(19) United States
(12) Patent Application Publication
(10) Pub. No.: US 2026/0258728 A1
(43) Pub. Date: Sep. 3, 2026

(54) RADIAL TURBINE WHEEL, RADIAL TURBINE, AND TURBOCHARGER

(71) Applicant: MITSUBISHI HEAVY INDUSTRIES ENGINE & TURBOCHARGER, LTD., Sagamihara-shi, Kanagawa (JP)

(72) Inventor: Yohei NAKAMURA, Tokyo (JP)

(73) Assignee: MITSUBISHI HEAVY INDUSTRIES ENGINE & TURBOCHARGER, LTD., Sagamihara-shi, Kanagawa (JP)

(21) Appl. No.: 19/162,272

(22) PCT Filed: Mar. 30, 2023
(86) PCT No.: PCT/JP2023/013364

§ 371 Date: Sep. 4, 2025

(51) Int. Cl. F04D 29/28; F04D 17/10

(52) U.S. Cl. CPC F01D 5/048; F04D 17/10; F04D 29/284; F05D 2220/40; F05D 2240/303; F05D 2240/304

(57) ABSTRACT

This radial turbine wheel comprises: a hub configured to be fixed to a rotating shaft; and a plurality of turbine blades disposed at intervals in the circumferential direction on a hub surface of the hub. Each of the plurality of turbine blades includes a leading edge, a hub-side edge, and a shroud-side edge. The leading edge has a leading-edge hub side end connected to the hub-side edge, and a leading-edge shroud side end connected to the shroud-side edge. When the entire length of the leading edge in a span direction is defined as La and the span-direction distance between a position displaced from the leading-edge hub side end toward the leading-edge shroud side end in the span direction and the leading-edge hub side end is defined as Ls, the leading edge of at least one of the plurality of turbine blades is configured to have a blade thickness that continuously decreases as Ls/La increases from 0.2 to 1.0.

### TECHNICAL FIELD

The present disclosure relates to a radial turbine wheel, a radial turbine, and a turbocharger.

### BACKGROUND ART

In a radial turbine disclosed in PTL 1, in order to avoid resonance of a turbine rotor blade, a blade thickness of a predetermined portion between a leading edge and a trailing edge of the turbine rotor blade is made thicker than a blade thickness of the leading edge.

### CITATION LIST

### Patent Literature

[PTL 1] Japanese Patent No. 6025961

### SUMMARY OF INVENTION

### Technical Problem

However, in the turbine rotor blade described above, the leading edge is thin, and in a case where pulsation of a flow of gas flowing into the turbine occurs, for example, at the leading edge, separation of the flow of the gas may occur, and there is a concern that turbine efficiency may be decreased.

An object of the present disclosure is to provide a radial turbine wheel, a radial turbine, and a turbocharger with which turbine efficiency is improved.

### Solution to Problem

According to at least one embodiment of the present disclosure, there is provided a radial turbine wheel including: a hub configured to be fixed to a rotary shaft; and a plurality of turbine blades disposed on a hub surface of the hub at intervals in a circumferential direction, in which each of the plurality of turbine blades includes a leading edge, a hub-side edge, and a shroud-side edge, the leading edge has a leading edge hub-side end connected to the hub-side edge and a leading edge shroud-side end connected to the shroud-side edge, and in a case where a total length of the leading edge in a span direction is defined as La and a span direction distance between a position displaced in the span direction from the leading edge hub-side end toward the leading edge shroud-side end and the leading edge hub-side end is defined as Ls, at least one leading edge of the plurality of turbine blades is configured such that a blade thickness of the leading edge is continuously decreased as Ls/La is increased from 0.2 to 1.0.

According to another embodiment of the present disclosure, there is provided a radial turbine including: a rotary shaft; the radial turbine wheel described above, which is fixed to one end portion of the rotary shaft; a turbine housing that accommodates the radial turbine wheel and that defines an annular nozzle flow path on an outer peripheral side of the radial turbine wheel; and a plurality of nozzle vanes disposed at the nozzle flow path at intervals in a circumferential direction.

According to still another embodiment of the present disclosure, there is provided a turbocharger including: the radial turbine described above; and a compressor including a compressor wheel fixed to the other end portion of the rotary shaft and a compressor housing that accommodates the compressor wheel.

### Advantageous Effects of Invention

According to the present disclosure, it is possible to provide a radial turbine wheel, a radial turbine, and a turbocharger with which turbine efficiency is improved.

### BRIEF DESCRIPTION OF DRAWINGS

FIG. 1 is a schematic explanatory view of a turbocharger according to an embodiment.

FIG. 2 is a schematic view of a radial turbine as viewed in an axial direction according to the embodiment.

FIG. 3 is a schematic meridian sectional view of a radial turbine wheel according to the embodiment.

FIG. 4 is a schematic graph illustrating a blade thickness of a leading edge according to the embodiment.

FIG. 5 is a schematic graph illustrating a relationship between D_{0.5}/D_{1.0} and turbine efficiency.

FIG. 6 is a schematic graph illustrating a relationship between D_{0.3}/D_{1.0} and turbine efficiency.

FIG. 7 is a view illustrating a schematic blade cross-section of a turbine blade according to the embodiment.

FIG. 8 is a schematic graph illustrating a blade thickness of the turbine blade according to the embodiment according to a position in a span direction.

FIG. 9 is a schematic graph illustrating a relationship between D_{0.5}/W_{0.5} and turbine efficiency.

FIG. 10 is a schematic graph illustrating a relationship between D_{0.3}/W_{0.5} and turbine efficiency.

### DESCRIPTION OF EMBODIMENTS

Hereinafter, some embodiments of the present disclosure will be described with reference to the accompanying drawings. Dimensions, materials, shapes, relative arrangements, and the like of components described as embodiments or illustrated in the drawings are not intended to limit the scope of the present disclosure, but are merely explanatory examples.

For example, an expression representing a relative or absolute arrangement such as “in a certain direction”, “along a certain direction”, “parallel”, “orthogonal”, “center”, “concentric”, or “coaxial” does not strictly represent only such an arrangement, but also a tolerance or a state of being relatively displaced with an angle or a distance to the extent that the same function can be obtained.

For example, expressions such as “identical”, “equal”, and “homogeneous” indicating that things are in an equal state do not strictly represent only the equal state, but also a tolerance or a state where there is a difference to the extent that the same function can be obtained.

For example, an expression representing a shape such as a quadrangular shape or a cylindrical shape does not represent only a shape such as a quadrangular shape or a cylindrical shape in a geometrically strict sense, but also a shape including an uneven portion, a chamfered portion, and the like within a range in which the same effect can be obtained.

Meanwhile, expressions such as “being provided with”, “including”, or “having” one component are not exclusive expressions excluding existence of other components.

The same configurations are denoted by the same reference numerals, and the description thereof may be omitted.

### <Overall Description of Turbocharger 1>

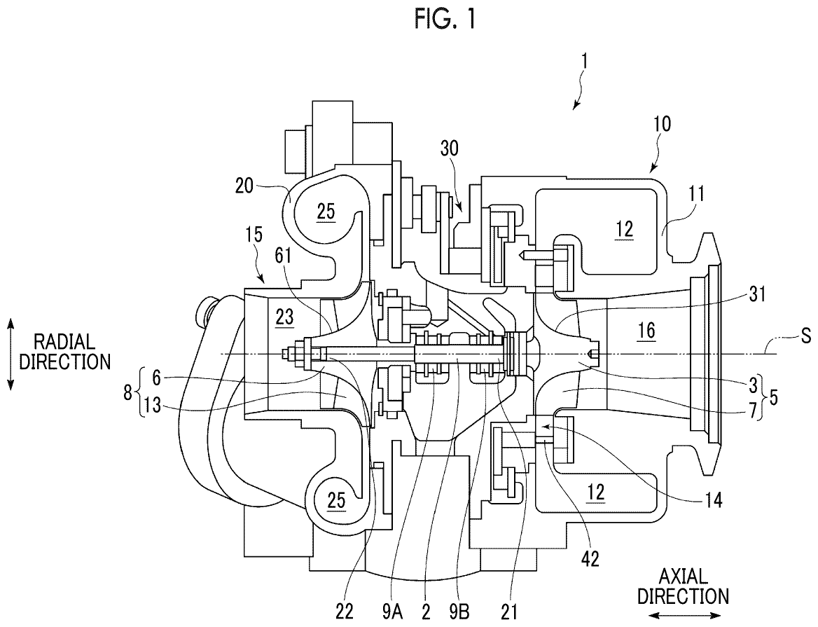

FIG. 1 is a schematic explanatory view of a turbocharger 1 according to an embodiment of the present disclosure. The turbocharger 1 described in the present example is mounted in an engine for power generation of a hybrid vehicle.

In the following description, a direction in which a rotary shaft 2, which is a component of the turbocharger 1, extends is referred to as an “axial direction”, and a circumferential direction and a radial direction with reference to an axis line S of the rotary shaft 2 may be simply referred to as a “circumferential direction” and a “radial direction”. An outer side in the radial direction is a side in a direction away from the axis line S, and an inner side in the radial direction is a side in a direction close to the axis line S.

The turbocharger 1 illustrated in FIG. 1 includes the rotary shaft 2, a radial turbine 10 provided on one end side of the rotary shaft 2, and a compressor 15 provided on the other end side of the rotary shaft 2. The rotary shaft 2 is rotatably supported by journal bearings 9A and 9B accommodated in a bearing housing 30.

The compressor 15 includes a compressor wheel 8 that is fixed to the other end portion 22 of the rotary shaft 2, and a compressor housing 20 that accommodates the compressor wheel 8. The compressor wheel 8 includes a compressor hub 6 in a truncated cone shape, which is fixed to the other end portion 22 of the rotary shaft 2, and a plurality of compressor blades 13 disposed at intervals in the circumferential direction on a hub surface 61 of the compressor hub 6. A suction port 23 that guides air from an outside of the compressor housing 20 to the compressor wheel 8 and a scroll flow path 25 for guiding the air compressed by the compressor wheel 8 to a power generation engine are formed inside the compressor housing 20.

The radial turbine 10 of the present example includes a radial turbine wheel 5 that is fixed to one end portion 21 of the rotary shaft 2. The radial turbine wheel 5 includes a frustum-shaped turbine hub 3 fixed to the one end portion 21 of the rotary shaft 2, and a plurality of turbine blades 7 disposed on a hub surface 31 of the turbine hub 3 at intervals in the circumferential direction. Further, the radial turbine 10 includes a turbine housing 11 that accommodates the radial turbine wheel 5 and that defines an annular nozzle flow path 14 on an outer peripheral side of the radial turbine wheel 5, and a plurality of nozzle vanes 42 provided in the nozzle flow path 14.

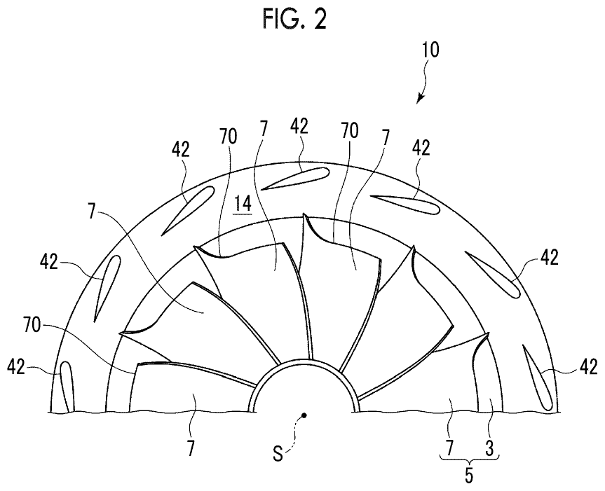

FIG. 2 is a schematic view of the radial turbine 10 as viewed in the axial direction according to the embodiment of the present disclosure. The plurality of nozzle vanes 42 are disposed at intervals in the circumferential direction. Each of the plurality of nozzle vanes 42 is a fixed nozzle vane that is mounted to the turbine housing 11 to be non-rotatable. The fixed nozzle vane is fixed to a wall surface defining the nozzle flow path 14 to be non-rotatable.

With reference to FIG. 1, in addition to the nozzle flow path 14 described above, a scroll flow path 12 through which exhaust gas introduced from an outside of the turbine housing 11 flows and an outlet flow path 16 for leading the exhaust gas for driving the radial turbine wheel 5 to the outside of the turbine housing 11 are formed inside the turbine housing 11 of the present example. The scroll flow path 12 is a flow path in a scroll shape formed on an outer peripheral side of the nozzle flow path 14. The outlet flow path 16 is a tubular flow path extending along the axis line S. The exhaust gas discharged from the power generation engine flows through the scroll flow path 12 and the nozzle flow path 14 in this order, and flows into the radial turbine wheel 5. Then, the exhaust gas in which the radial turbine wheel 5 is rotationally driven flows through the outlet flow path 16 along the axis line S and is discharged to the outside of the turbine housing 11.

### <Leading Edge 70 of Turbine Blade 7>

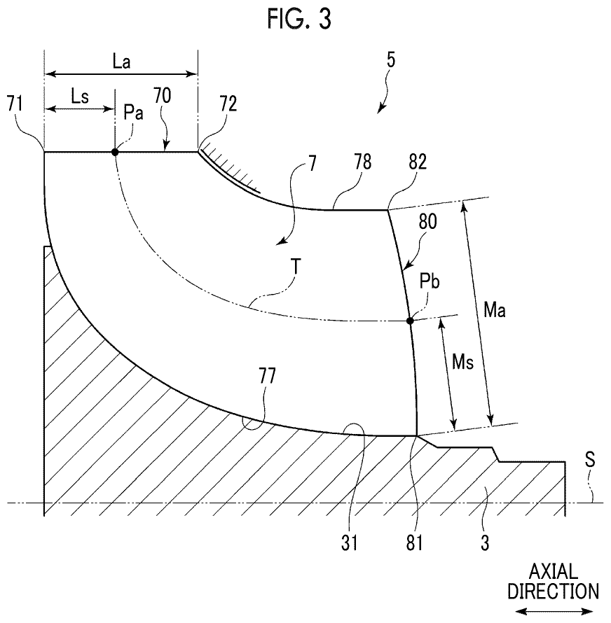

FIG. 3 is a schematic meridian cross-sectional view of the radial turbine wheel 5 according to the embodiment of the present disclosure. Each of the plurality of turbine blades 7 includes a leading edge 70, a hub-side edge 77 connected to the hub surface 31, a shroud-side edge 78, and a trailing edge 80. The leading edge 70 has a leading edge hub-side end 71 connected to the hub-side edge 77 and a leading edge shroud-side end 72 connected to the shroud-side edge 78.

In the following description, a total length of the leading edge 70 in a span direction is defined as La. In addition, a span direction distance between a position (point Pa in FIG. 3) displaced in the span direction from the leading edge hub-side end 71 toward the leading edge shroud-side end 72 and the leading edge hub-side end 71 is defined as Ls. La is a constant value, and Ls is a value that varies in a range from 0 to La.

At least one leading edge 70 of the plurality of turbine blades 7 is configured such that a blade thickness of the leading edge 70 is continuously decreased as Ls/La is increased from 0.2 to 1.0. A range in which the blade thickness of the leading edge 70 is continuously decreased may include a range in which Ls/La is 0.2 or more and 1.0 or less, and, for example, the blade thickness of the leading edge 70 may be continuously decreased as Ls/La is increased from 0.1 to 1.0.

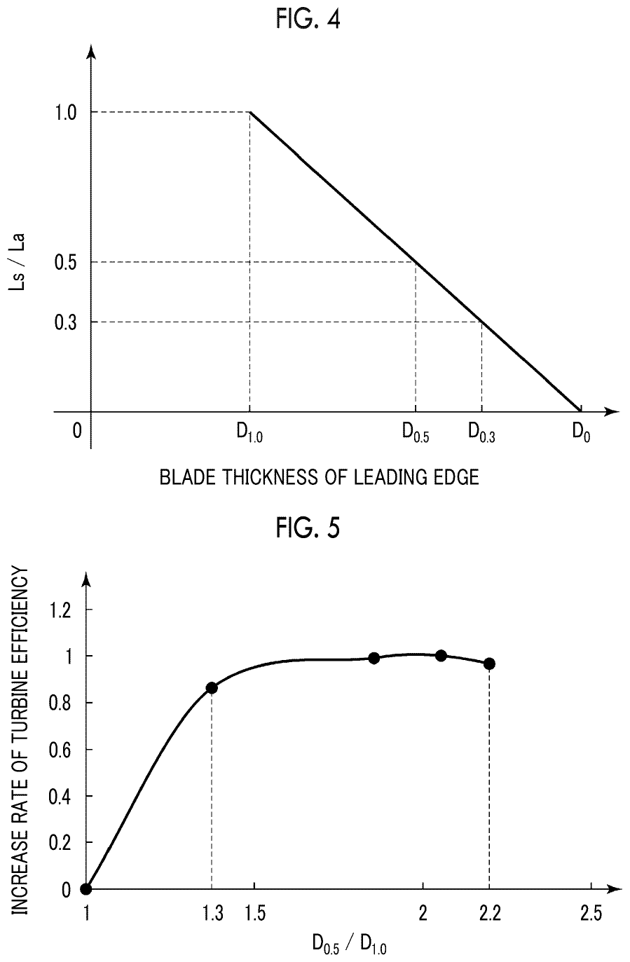

FIG. 4 is a schematic graph illustrating the blade thickness of the leading edge 70 according to the embodiment of the present disclosure, in which a horizontal axis indicates the thickness of the leading edge 70 and a vertical axis indicates Ls/La. In the example of the graph, as Ls/La is increased from 0 to 1.0, the blade thickness of the leading edge 70 is continuously decreased. However, the present disclosure is not limited to the case where the blade thickness of the leading edge 70 is linearly changed as illustrated in the drawing according to the change amount of Ls/La, and the blade thickness of the leading edge 70 may be changed in a curved manner.

According to the configuration described above, a portion of the leading edge 70 on the turbine hub 3 side can be thickened, and the flow of the supplied exhaust gas can be prevented from being disturbed at the leading edge 70. Since a secondary flow loss is suppressed, the radial turbine wheel 5 with which turbine efficiency is improved is implemented.

In the related art, it has been required to reduce a weight of the radial turbine wheel 5 by making a portion on the turbine hub 3 side as thin as possible on the premise that a required strength of the turbine blade 7 is achieved. This is because the radial turbine wheel 5 has appropriate transient response due to the weight reduction. However, in the turbocharger 1 mounted in a power generation engine of a hybrid vehicle, an output fluctuation of the hybrid vehicle is dealt with by an output fluctuation of a battery mounted in the hybrid vehicle, and an operation point of the power generation engine is likely to be narrowed down to almost one point. In the radial turbine wheel 5 of the turbocharger 1 as described above, improvement in turbine efficiency is more important than transient responsiveness. In this regard, according to the configuration described above, the portion of the leading edge 70 on the turbine hub 3 side is thickened, so that the flow of the exhaust gas is prevented from being disturbed at the leading edge 70, and high turbine efficiency is achieved.

In addition, according to the configuration in which the nozzle vane 42 is the fixed nozzle vane, a discharge angle of the exhaust gas in the nozzle vane 42 is constant. Therefore, in a case where pulsation of the flow of the supplied exhaust gas occurs, an inlet loss is likely to be increased. In this regard, according to the configuration in which the blade thickness of the leading edge 70 is continuously decreased as Ls/La is increased from 0.2 to 1.0, it is possible to suppress turbulence of the flow of the exhaust gas at the leading edge 70 and to improve turbine efficiency.

The description of the shape of the leading edge 70 will be continued. In the graph in FIG. 4, the blade thickness of the leading edge 70 at a position in the span direction at which Ls/La is 0.5 corresponds to D_{0.5}, and the blade thickness of the leading edge 70 at a position in the span direction at which Ls/La is 1.0 corresponds to D_{1.0}. Although not an essential component of the present disclosure, D_{0.5} may be 1.3 times or more and 2.2 times or less D_{1.0}, and more preferably may be 1.3 times or more and 2.0 times or less D_{1.0}.

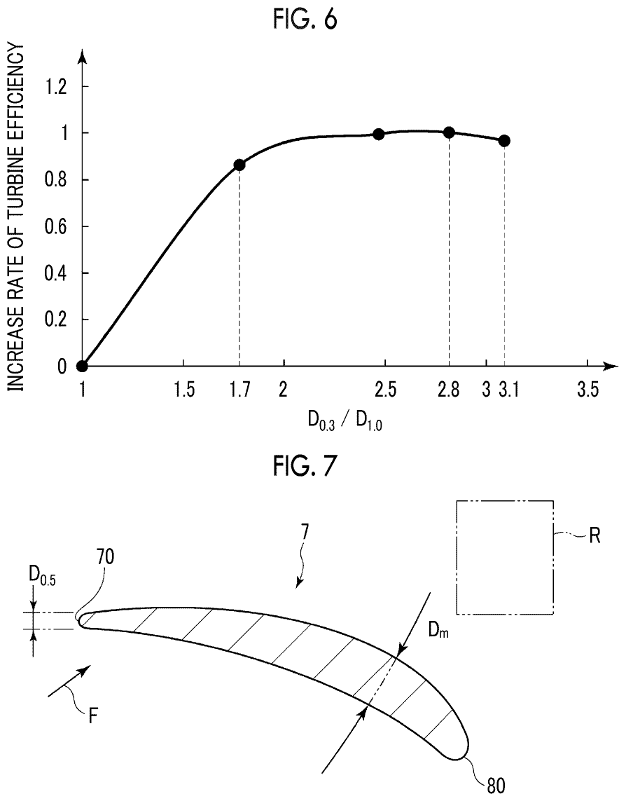

FIG. 5 is a schematic graph in which a relationship between D_{0.5}/D_{1.0} and turbine efficiency is specified by simulation. In the simulation, D_{0.5} is changed under a condition in which a value of D_{1.0} is constant, and the turbine efficiency corresponding to D_{0.5}/D_{1.0} is specified. In addition, in the simulation, an outer diameter of the radial turbine wheel 5 is set to 40 mm (the same condition is set in simulation results illustrated in FIGS. 6, 9, and 10 to be described later).

A vertical axis of the graph illustrated in FIG. 5 indicates an increase rate of efficiency having the turbine efficiency of a radial turbine wheel (not illustrated) in which D_{0.5}/D_{1.0} is 1 as a reference. As can be seen from the graph, when D_{0.5}/D_{1.0} is 1.3 or more and 2.2 or less, gas turbulence at the leading edge 70 can be significantly suppressed, and a secondary flow loss in the turbine blade 7 can be significantly reduced. As a result, the increase rate of the turbine efficiency exceeds 0.8 (that is, 80%). The increase rate of the turbine efficiency is maximized when D_{0.5}/D_{1.0} is 2.0.

As described above, according to the configuration in which D_{0.5} is 1.3 times or more and 2.2 times or less D_{1.0}, and more preferably, according to the configuration in which D_{0.5} is 1.3 times or more and 2.0 times or less D_{1.0}, even in a case where pulsation occurs in the flow of the supplied exhaust gas, the turbulence of the flow of the exhaust gas can be suppressed at the leading edge 70, and the secondary flow loss in the turbine blade 7 can be reduced. Therefore, the turbine efficiency can be improved.

With reference to FIG. 4, the blade thickness of the leading edge 70 at a position in the span direction at which Ls/La is 0.3 corresponds to D_{0.3}. Although not an essential component of the present disclosure, D_{0.3} may be 1.7 times or more and 3.1 times or less D_{1.0}, and more preferably may be 1.7 times or more and 2.8 times or less D_{1.0}.

FIG. 6 is a schematic graph in which a relationship between D_{0.3}/D_{1.0} and turbine efficiency is specified by simulation. In the simulation, D_{0.3} is changed under a condition in which the value of D1.0 is constant, and the turbine efficiency corresponding to D_{0.3}/D_{1.0} is specified.

A vertical axis of the graph indicates an increase rate of efficiency having the turbine efficiency of a radial turbine wheel (not illustrated) in which D_{0.3}/D_{1.0} is 1 as a reference. As can be seen from the graph, when D_{0.3}/D_{1.0} is 1.7 or more and 3.1 or less, gas turbulence at the leading edge 70 can be significantly suppressed, and a secondary flow loss in the turbine blade 7 can be significantly reduced. As a result, the increase rate of the turbine efficiency exceeds 0.8 (that is, 80%). The increase rate of the turbine efficiency is maximized when D_{0.3}/D_{1.0} is 2.8.

As described above, according to the configuration in which D_{0.3} is 1.7 times or more and 3.1 times or less D_{1.0}, and more preferably, according to the configuration in which D_{0.3} is 1.3 times or more and 2.8 times or less D_{1.0}, even in a case where pulsation occurs in the flow of the supplied exhaust gas, the turbulence of the flow of the exhaust gas can be suppressed at the leading edge 70, and the secondary flow loss in the turbine blade 7 can be reduced. Therefore, the turbine efficiency can be improved.

FIG. 7 illustrates a schematic blade cross-section of the turbine blade 7 at an intermediate position in the span direction between the hub-side edge 77 and the shroud-side edge 78. The blade cross-section in FIG. 7 is a blade cross-section of the turbine blade 7 at a dashed double-dotted line T when Ls in FIG. 3 is 50% of La and Ms is 50% of Ma. The blade thickness of the leading edge 70 illustrated in FIG. 7 corresponds to D_{0.5} described above. In addition, an arrow F indicates a flow direction of the supplied exhaust gas. Further, the maximum blade thickness in the blade cross-section corresponds to a dimension Dₘ. Dₘ is a value larger than D_{0.5}.

Although not an essential component of the present disclosure, Dₘ may be 2.0 times or less D_{0.5}, and more preferably may be 1.3 times or less D_{0.5}. In the blade cross-section illustrated in FIG. 7, a portion at which Dₘ is formed is in a range of a meridian plane length ratio of 50% to 80%. Here, the meridian plane length ratio indicates a ratio of a meridian plane length between a position displaced in a chord direction (blade chord line direction) from the leading edge 70 toward the trailing edge 80 and the leading edge 70 to a meridian plane length from the leading edge 70 to the trailing edge 80.

The larger the blade thickness of the substantially central portion of the turbine blade 7 in the chord direction, the more likely a wake is to occur in a region R on a suction side with respect to the trailing edge 80 of the turbine blade 7. In this regard, according to the configuration described above, since the blade thickness of the turbine blade 7 at the substantially central portion in the chord direction can be reduced, the occurrence of the wake can be suppressed. According to the simulation performed by the inventors of the present application, the suppression of the wake is checked when Dₘ is 2.0 times or less D_{0.5}, and the wake is more significantly suppressed when Dₘ is 1.3 times or less D_{0.5}.

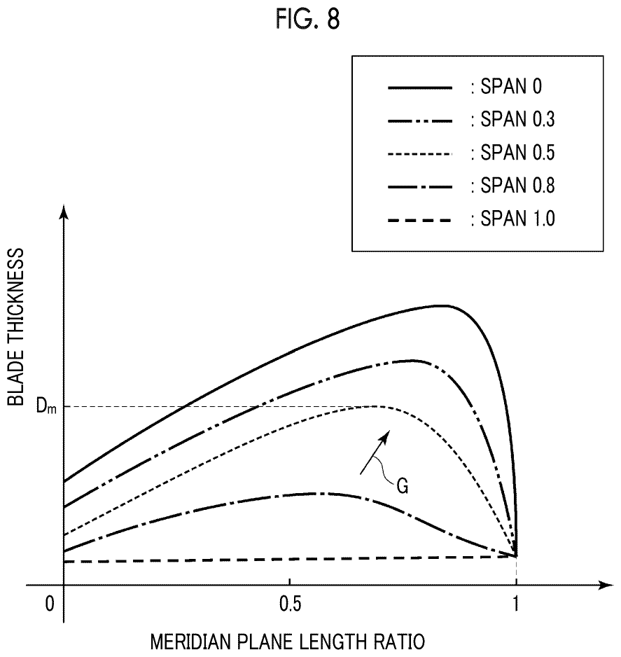

FIG. 8 is a schematic graph illustrating a blade thickness of the turbine blade 7 according to the embodiment according to a position in the span direction. A vertical axis of the graph indicates the blade thickness of the turbine blade 7. A horizontal axis indicates a meridian plane length ratio. Therefore, a blade thickness at which a value of the horizontal axis is “0” indicates the blade thickness of the leading edge 70, and the blade thickness at which the value of the horizontal axis is “1” indicates a thickness of the trailing edge 80. In the graph, a blade thickness of the hub-side edge 77 is indicated by a graph line of “span 0”, and a blade thickness of the shroud-side edge 78 is indicated by a graph line of “span 1.0”. In addition, the graph line of “span 0.5” indicates the blade thickness of the turbine blade 7 at an intermediate position in the span direction between the leading edge 70 and the shroud-side edge 78, and Dₘ is the same value as Dₘ illustrated in FIG. 7. Further, the graph lines of “span 0.3” and “span 0.8” indicate the blade thickness of the blade cross-section displaced by 30% and 80% in the span direction from the hub-side edge 77 toward the shroud-side edge 78. These 30% and 80% are numerical values calculated with reference to a total length of the turbine blade 7 in the span direction from the hub-side edge 77 to the shroud-side edge 78.

As indicated by an arrow G in the same graph, in the present example, the turbine blade 7 is configured such that the maximum blade thickness appears on the trailing edge 80 side in the chord direction as the displacement approaches the shroud-side edge 78 in the span direction. In addition, as indicated by the graph line of “span 1.0”, the blade thickness of the shroud-side edge 78 is substantially constant regardless of the position in the chord direction.

<Relationship between Leading Edge 70 and Trailing Edge 80>

With reference to FIG. 3, the trailing edge 80 of the turbine blade 7 has a trailing edge hub-side end 81 connected to the hub-side edge 77 and a trailing edge shroud-side end 82 connected to the shroud-side edge 78.

In the following description, a total length of the trailing edge 80 in the span direction is defined as Ma. In addition, a span direction distance between a position (point Pb in FIG. 3) displaced in the span direction from the trailing edge hub-side end 81 toward the trailing edge shroud-side end 82 and the trailing edge hub-side end 81 is defined as Ms. Ma is a constant value, and Ms is a value that varies in a range from 0 to Ma.

Further, in the following description, a case where a blade thickness of the trailing edge 80 at a position in the span direction at which Ms/Ma is 0.5 is W_{0.5} and the blade thickness of the trailing edge 80 at a position in the span direction at which Ms/Ma is 0.3 is W_{0.3} will be described.

Although not an essential component of the present disclosure, D_{0.5} may be 1.3 times or more and 2.2 times or less W_{0.5}, and more preferably, D_{0.5} may be 1.3 times or more and 2.0 times or less W_{0.5}.

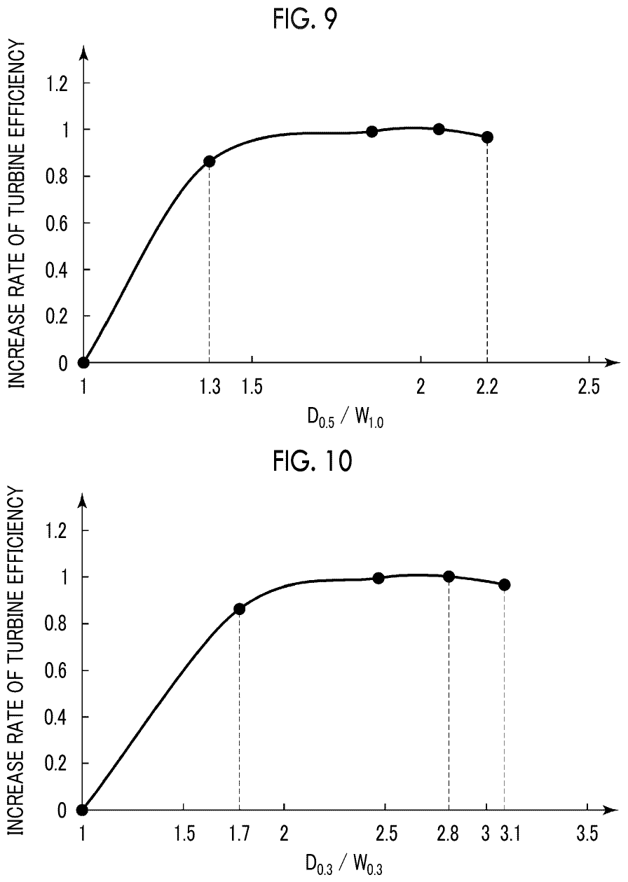

FIG. 9 is a graph in which a relationship between D_{0.5}/W_{0.5} and turbine efficiency is specified by simulation. In the simulation, D_{0.5} is changed under a condition in which the value of W_{0.5} is constant, and the turbine efficiency corresponding to D_{0.5}/W_{0.5} is specified.

A vertical axis of the graph indicates an increase rate of efficiency having the turbine efficiency of a radial turbine wheel (not illustrated) in which D_{0.5}/W_{0.5} is 1 as a reference. As can be seen from the same graph, when D_{0.5}/W_{0.5} is 1.3 or more and 2.2 or less, gas turbulence at the leading edge 70 can be significantly suppressed, and a secondary flow loss in the turbine blade 7 can be significantly reduced. As a result, the increase rate of the turbine efficiency exceeds 0.8 (that is, 80%). The increase rate of the turbine efficiency is maximized when D_{0.5}/W_{0.5} is 2.0.

As described above, according to the configuration in which D_{0.5} is 1.3 times or more and 2.2 times or less W_{0.5}, and more preferably, according to the configuration in which D_{0.5} is 1.3 times or more and 2.0 times or less W_{0.5}, even in a case where pulsation occurs in the flow of the supplied exhaust gas, the turbulence of the flow of the exhaust gas can be suppressed at the leading edge 70, and the secondary flow loss in the turbine blade 7 can be reduced. Therefore, the turbine efficiency can be improved.

Although not an essential component of the present disclosure, D_{0.3} may be 1.7 times or more and 3.1 times or less W_{0.3}, and more preferably, D_{0.3} may be 1.7 times or more and 2.8 times or less W_{0.3}.

FIG. 10 is a graph in which a relationship between D_{0.3}/W_{0.3} and turbine efficiency is specified by simulation. In the simulation, D_{0.3} is changed under a condition in which the value of W_{0.3} is constant, and the turbine efficiency corresponding to D_{0.3}/W_{0.3} is specified.

A vertical axis of the graph indicates an increase rate of efficiency having the turbine efficiency of a radial turbine wheel (not illustrated) in which D_{0.3}/W_{0.3} is 1 as a reference. As can be seen from the same graph, when D_{0.3}/W_{0.3} is 1.7 or more and 3.1 or less, gas turbulence at the leading edge 70 can be significantly suppressed, and a secondary flow loss in the turbine blade 7 can be significantly reduced. As a result, the increase rate of the turbine efficiency exceeds 0.8 (that is, 80%). The increase rate of the turbine efficiency is maximized when D_{0.3}/W_{0.3} is 2.8.

As described above, according to the configuration in which D_{0.3} is 1.7 times or more and 3.1 times or less W_{0.3}, and more preferably, according to the configuration in which D_{0.3} is 1.3 times or more and 2.8 times or less W_{0.3}, even in a case where pulsation occurs in the flow of the supplied exhaust gas, the turbulence of the flow of the exhaust gas can be suppressed at the leading edge 70, and the secondary flow loss in the turbine blade 7 can be reduced. Therefore, the turbine efficiency can be improved.

### Modification Examples

The nozzle vane 42 illustrated in FIG. 2 may be a variable nozzle vane that is rotatably mounted to the turbine housing 11. In this case, the variable nozzle vane is configured to be rotated by a driving force of an actuator being transmitted via a variable mechanism. In addition, the turbocharger 1 illustrated in FIG. 1 may not include the nozzle vane 42. However, in a case where the turbocharger 1 is mounted in a power generation engine of a hybrid vehicle in which an operation point is likely to be almost limited to one point, turbine efficiency is more important than transient responsiveness. Therefore, in the embodiment described above, the nozzle vane 42 is provided to improve the turbine efficiency.

### SUMMARY

For example, the contents described in some embodiments described above are understood as follows.
1) According to at least one embodiment of the present disclosure, a radial turbine wheel (5) includes:
a hub (turbine hub 3) configured to be fixed to a rotary shaft (2); and
a plurality of turbine blades (7) disposed on a hub surface (31) of the hub at intervals in a circumferential direction,
in which each of the plurality of turbine blades includes a leading edge (70), a hub-side edge (77), and a shroud-side edge (78),
the leading edge has a leading edge hub-side end (71) connected to the hub-side edge and a leading edge shroud-side end (72) connected to the shroud-side edge, and
in a case where a total length of the leading edge in a span direction is defined as La and a span direction distance between a position (point Pa) displaced in the span direction from the leading edge hub-side end toward the leading edge shroud-side end and the leading edge hub-side end is defined as Ls,
at least one leading edge of the plurality of turbine blades is configured such that a blade thickness of the leading edge is continuously decreased as Ls/La is increased from 0.2 to 1.0.

With the configuration of 1) described above, a portion on a hub side of the leading edge can be thickened, and a flow of supplied gas can be prevented from being disturbed at the leading edge. Since a secondary flow loss is suppressed, the radial turbine wheel with which turbine efficiency is improved is implemented.
2) In some embodiments, in the radial turbine wheel according to 1) described above,
the blade thickness (D_{0.5}) of the leading edge at a position in the span direction at which Ls/La is 0.5 is 1.3 times or more and 2.2 times or less the blade thickness (D_{1.0}) of the leading edge at a position in the span direction at which Ls/La is 1.0.

With the configuration of 2) described above, since the blade thickness of the leading edge can be increased, even in a case where pulsation of the flow of the supplied gas occurs, turbulence of the flow of the gas at the leading edge can be suppressed and a secondary flow loss in the turbine blade can be reduced. Therefore, a radial turbine wheel with which turbine efficiency is improved is implemented.
3) In some embodiments, in the radial turbine wheel according to 1) or 2) described above,
the blade thickness (D_{0.3}) of the leading edge at a position in the span direction at which Ls/La is 0.3 is 1.7 times or more and 3.1 times or less the blade thickness (D_{1.0}) of the leading edge at a position in the span direction at which Ls/La is 1.0.

With the configuration of 3) described above, since the blade thickness of the leading edge can be increased, even in a case where the pulsation of the flow of the supplied gas occurs, turbulence of the flow of the gas at the leading edge can be suppressed and a secondary flow loss in the turbine blade can be reduced. Therefore, a radial turbine wheel with which turbine efficiency is improved is implemented.
4) In some embodiments, in the radial turbine wheel according to any one of 1) to 3) described above,
a maximum blade thickness (Dₘ) of the turbine blade in a blade cross-section at an intermediate position in the span direction between the hub-side edge and the shroud-side edge is equal to or less than 2.0 times the blade thickness (D_{0.5}) of the leading edge at a position in the span direction at which Ls/La is 0.5.

With the configuration of 4) described above, since the blade thickness at the substantially central portion of the turbine blade in a chord direction can be reduced, occurrence of a wake on the trailing edge side of the turbine blade can be suppressed.
5) In some embodiments, in the radial turbine wheel according to any one of 1) to 4) described above,
each of the plurality of turbine blades includes a trailing edge (80),
the trailing edge has a trailing edge hub-side end (81) connected to the hub-side edge and a trailing edge shroud-side end (82) connected to the shroud-side edge, and
in a case where a total length of the trailing edge in the span direction is defined as Ma and a span direction distance between a position (point Pb) displaced in the span direction from the trailing edge hub-side end toward the trailing edge shroud-side end and the trailing edge hub-side end is defined as Ms,
the blade thickness (D_{0.5}) of the leading edge at a position in the span direction at which Ls/La is 0.5 is 1.3 times or more and 2.2 times or less a blade thickness (W_{0.5}) of the trailing edge at a position in the span direction at which Ms/Ma is 0.5.

With the configuration of 5) described above, since the blade thickness of the leading edge can be increased, even in a case where the pulsation of the flow of the supplied gas occurs, turbulence of the flow of the gas at the leading edge can be suppressed and a secondary flow loss in the turbine blade can be reduced. Therefore, a radial turbine wheel with which turbine efficiency is improved is implemented.
6) In some embodiments, in the radial turbine wheel according to any one of 1) to 5) described above,
each of the plurality of turbine blades includes a trailing edge (80),
the trailing edge has a trailing edge hub-side end (81) connected to the hub-side edge and a trailing edge shroud-side end (82) connected to the shroud-side edge, and
in a case where a total length of the trailing edge in the span direction is defined as Ma and a span direction distance between a position displaced in the span direction from the trailing edge hub-side end toward the trailing edge shroud-side end and the trailing edge hub-side end is defined as Ms,
the blade thickness (D_{0.3}) of the leading edge at a position in the span direction at which Ls/La is 0.3 is 1.7 times or more and 3.1 times or less a blade thickness (W_{0.3}) of the trailing edge at a position in the span direction at which Ms/Ma is 0.3.

With the configuration of 6) described above, since the blade thickness of the leading edge can be increased, even in a case where the pulsation of the flow of the supplied gas occurs, turbulence of the flow of the gas at the leading edge can be suppressed and a secondary flow loss in the turbine blade can be reduced. Therefore, a radial turbine wheel with which turbine efficiency is improved is implemented.
7) According to at least one embodiment of the present disclosure, a radial turbine (10) includes:
a rotary shaft (2);
the radial turbine wheel according to any one of 1) to 6), which is fixed to one end portion (21) of the rotary shaft;
a turbine housing (11) that accommodates the radial turbine wheel and that defines an annular nozzle flow path (14) on an outer peripheral side of the radial turbine wheel; and
a plurality of nozzle vanes (42) disposed at the nozzle flow path at intervals in a circumferential direction.

With the configuration of 7) described above, the same technical advantages as those of 1) described above can be obtained.
8) In the radial turbine according to at least one embodiment of the present disclosure,
each of the plurality of nozzle vanes is mounted to the turbine housing to be non-rotatable.

With the configuration of 8) described above, in the fixed nozzle type radial turbine, a discharge angle of the gas in the nozzle vane is constant. Therefore, in a case where the pulsation of the flow of the supplied gas occurs, an inlet loss is likely to be increased. In this regard, according to the configuration of 8) described above, the blade thickness of the leading edge of the turbine blade is increased, so that the turbulence of the gas flow at the leading edge can be suppressed and turbine efficiency can be improved.
9) According to at least one embodiment of the present disclosure, a turbocharger includes:
the radial turbine (10) according to 7) described above; and
a compressor (15) including a compressor wheel (8) fixed to the other end portion of the rotary shaft and a compressor housing (20) that accommodates the compressor wheel.

With the configuration of 9) described above, the same technical advantages as those of 1) described above can be obtained.

### REFERENCE SIGNS LIST

1: Turbocharger
2: Rotary shaft
3: Turbine hub (hub)
5: Radial turbine wheel
7: Turbine blade
8: Compressor wheel
10: Radial turbine
11: Turbine housing
14: Nozzle flow path
15: Compressor
20: Compressor housing
21: One end portion
22: Other end portion
31: Hub surface
42: Nozzle vane
61: Hub surface
70: Leading edge
71: Leading edge hub-side end
72: Leading edge shroud-side end
77: Hub-side edge
78: Shroud-side edge
80: Trailing edge
81: Trailing edge hub-side end
82: Trailing edge shroud-side end
Pa, Pb: Point

1. A radial turbine wheel comprising:
a hub configured to be fixed to a rotary shaft; and
a plurality of turbine blades disposed on a hub surface of the hub at intervals in a circumferential direction,
wherein each of the plurality of turbine blades includes a leading edge, a hub-side edge, and a shroud-side edge,
the leading edge has a leading edge hub-side end connected to the hub-side edge and a leading edge shroud-side end connected to the shroud-side edge, and
in a case where a total length of the leading edge in a span direction is defined as La and a span direction distance between a position displaced in the span direction from the leading edge hub-side end toward the leading edge shroud-side end and the leading edge hub-side end is defined as Ls,
at least one leading edge of the plurality of turbine blades is configured such that a blade thickness of the leading edge is continuously decreased as Ls/La is increased from 0.2 to 1.0.

2. The radial turbine wheel according to claim 1,
wherein the blade thickness of the leading edge at a position in the span direction at which Ls/La is 0.5 is 1.3 times or more and 2.2 times or less the blade thickness of the leading edge at a position in the span direction at which Ls/La is 1.0.

3. The radial turbine wheel according to claim 1,
wherein the blade thickness of the leading edge at a position in the span direction at which Ls/La is 0.3 is 1.7 times or more and 3.1 times or less the blade thickness of the leading edge at a position in the span direction at which Ls/La is 1.0.

4. The radial turbine wheel according to claim 1,
wherein a maximum blade thickness of the turbine blade in a blade cross-section at an intermediate position in the span direction between the hub-side edge and the shroud-side edge is equal to or less than 2.0 times the blade thickness of the leading edge at a position in the span direction at which Ls/La is 0.5.

5. The radial turbine wheel according to claim 1,
wherein each of the plurality of turbine blades includes a trailing edge,
the trailing edge has a trailing edge hub-side end connected to the hub-side edge and a trailing edge shroud-side end connected to the shroud-side edge, and
in a case where a total length of the trailing edge in the span direction is defined as Ma and a span direction distance between a position displaced in the span direction from the trailing edge hub-side end toward the trailing edge shroud-side end and the trailing edge hub-side end is defined as Ms,
the blade thickness of the leading edge at a position in the span direction at which Ls/La is 0.5 is 1.3 times or more and 2.2 times or less a blade thickness of the trailing edge at a position in the span direction at which Ms/Ma is 0.5.

6. The radial turbine wheel according to claim 1,
wherein each of the plurality of turbine blades includes a trailing edge,
the trailing edge has a trailing edge hub-side end connected to the hub-side edge and a trailing edge shroud-side end connected to the shroud-side edge, and
in a case where a total length of the trailing edge in the span direction is defined as Ma and a span direction distance between a position displaced in the span direction from the trailing edge hub-side end toward the trailing edge shroud-side end and the trailing edge hub-side end is defined as Ms,
the blade thickness of the leading edge at a position in the span direction at which Ls/La is 0.3 is 1.7 times or more and 3.1 times or less a blade thickness of the trailing edge at a position in the span direction at which Ms/Ma is 0.3.

7. A radial turbine comprising:
a rotary shaft;
the radial turbine wheel according to claim 1, which is fixed to one end portion of the rotary shaft,
a turbine housing that accommodates the radial turbine wheel and that defines an annular nozzle flow path on an outer peripheral side of the radial turbine wheel; and
a plurality of nozzle vanes disposed at the nozzle flow path at intervals in a circumferential direction.

8. The radial turbine according to claim 7,
wherein each of the plurality of nozzle vanes is mounted to the turbine housing to be non-rotatable.

9. A turbocharger comprising:
the radial turbine according to claim 7; and
a compressor including a compressor wheel fixed to the other end portion of the rotary shaft and a compressor housing that accommodates the compressor wheel.
